(19) United States
(12) Patent Application Publication
(10) Pub. No.: US 2024/0302729 A1
(43) Pub. Date: Sep. 12, 2024

(54) LIGHT HOMOGENIZATION MODULE AND PROJECTION APPARATUS

(71) Applicant: Coretronic Corporation, Hsin-Chu (TW)

(72) Inventor: Hou-Sheng Wang, Hsin-Chu (TW)

(73) Assignee: Coretronic Corporation, Hsin-Chu (TW)

(21) Appl. No.: 18/596,636

(22) Filed: Mar. 6, 2024

(30) Foreign Application Priority Data
Mar. 7, 2023 (CN) 202310208651.9

(51) Int. Cl. G03B 21/20; G02B 27/09

(52) U.S. Cl. CPC G03B 21/208; G02B 27/0927; G02B 27/0994

(57) ABSTRACT

A light homogenization module includes an integration rod, a first diffusively reflective element, and a second diffusively reflective element. The integration rod has a light inlet and an inner surface. The first diffusively reflective element is disposed on the inner surface of the integration rod. The second diffusively reflective element is disposed on the inner surface of the integration rod and adjacent to the first diffusively reflective element. The second diffusively reflective element is disposed between the first diffusively reflective element and the light inlet of the integration rod. A haze of the first diffusively reflective element is greater than a haze of the second diffusively reflective element. A projection apparatus is also provided.

### CROSS-REFERENCE TO RELATED APPLICATION

This application claims the priority benefit of Chinese application no. 202310208651.9, filed on Mar. 7, 2023. The entirety of the above-mentioned patent application is hereby incorporated by reference herein and made a part of this specification.

### BACKGROUND

### Technical Field

The disclosure relates to an optical module and a device. Particularly, the disclosure relates to a light homogenization module and a projection apparatus.

### Description of Related Art

A projector that adopts pure laser as a light source may effectively improve purification of colors and color gamuts. Due to breakthrough in the bottleneck of laser technology and reduction in cost in recent years, a projector with a laser light source is able to be popularized and gradually accepted by the market.

However, even the adoption of a diffuser or a beam splitter of the current technology still provides not much help in solving speckles caused by the projector using the pure laser light source. The main reason is that a laser light source module is formed by a point light source array, which leads to limitations in the angular distribution thereof. Moreover, the current technology has limited influence on the change in the chief ray angle of laser. As a result, solutions to the above-mentioned issues by relevant manufacturers are still required.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a light homogenization module, which may effectively achieve despeckling and achieves good light homogenization.

The disclosure also provides a projection apparatus, which may effectively reduce speckle, and effectively improve purification of colors and color gamuts to achieve good image quality.

An embodiment of the disclosure provides a light homogenization module including an integration rod, a first diffusively reflective element, and a second diffusively reflective element. The integration rod has a light inlet and an inner surface. The first diffusively reflective element is disposed on the inner surface of the integration rod. The second diffusively reflective element is disposed on the inner surface of the integration rod and adjacent to the first diffusively reflective element. The second diffusively reflective element is disposed between the first diffusively reflective element and the light inlet of the integration rod. A haze of the first diffusively reflective element is greater than a haze of the second diffusively reflective element.

An embodiment of the disclosure provides a projection apparatus including the above-mentioned light homogenization module, an illumination system, a light valve, and a projection lens. The illumination system configured to output an illumination light beam. The light homogenization module is disposed on a transmission path of the illumination light beam and homogenizing the illumination light beam. The light valve is disposed on a transmission path of the illumination light beam homogenized by the light homogenization module. The light valve converts the illumination light beam into an image light beam. The projection lens is disposed on a transmission path of the image light beam.

Based on the foregoing, in the light homogenization module and the projection apparatus of the embodiments of the disclosure, the integration rod includes the first diffusively reflective element and the second diffusively reflective element with different hazes on the inner surface. As a result, under the same length of the integration rod, it is possible to effectively improve the light homogenization capability of the incident light within a small angle range, and also reduce the loss of light energy caused by diffusion of the incident light at a large angle. Moreover, the light beam is fully homogenized in the integration rod to technically achieve despeckling or reducing speckle contrast, and provide good image quality. In addition, under the same condition of light homogenization, since the integration rod of an embodiment of the disclosure may cause light homogenization with different internal diffusively reflective elements corresponding to incident lights at different angles, an excessively great number of reflections is not required to fully achieve light homogenization for incident light at a small angle. As a result, the length of the integration rod may be further reduced, which in turn further reduces the overall volume of the projection apparatus, facilitating miniaturization of the projection apparatus.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional view of a light homogenization module of an embodiment of the disclosure.

FIG. 2 is a schematic cross-sectional view of a light homogenization module of another embodiment of the disclosure.

FIG. 3 is a schematic view of an optical path of a projection apparatus of an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

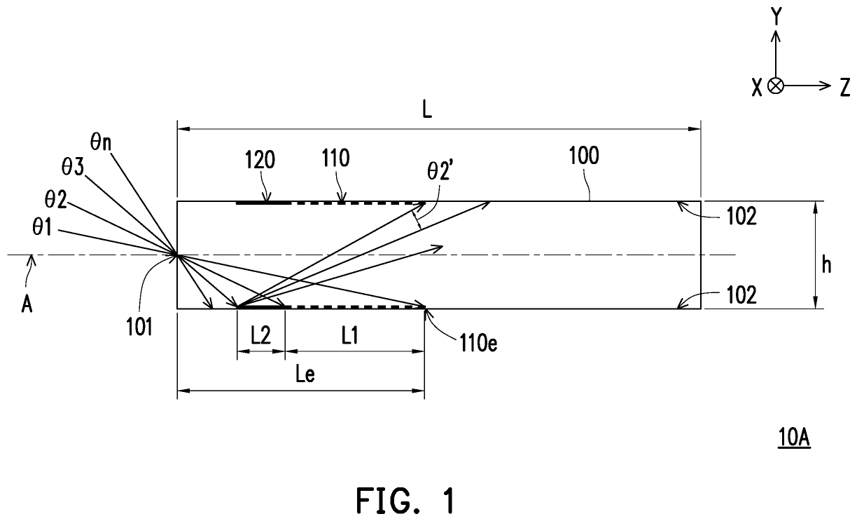

FIG. 1 is a schematic cross-sectional view of a light homogenization module of an embodiment of the disclosure. With reference to FIG. 1, a light homogenization module 10A includes an integration rod 100, a first diffusively reflective element 110, and a second diffusively reflective element 120. The integration rod 100 has a light inlet 101 and an inner surface 102. The first diffusively reflective element 110 is disposed on the inner surface 102 of the integration rod 100. The second diffusively reflective element 120 is disposed on the inner surface 102 of the integration rod 100 and adjacent to the first diffusively reflective element 110. The second diffusively reflective element 120 is disposed between the first diffusively reflective element 110 and the light inlet 101 of the integration rod 100.

In the embodiment of the disclosure, the material of the integration rod 100 may be glass or plastic. The inner surface 102 may be formed of a reflective mirror. Since the first diffusively reflective element 110 and the second diffusively reflective element 120 are disposed on the inner surface 102 of the integration rod 100, the integration rod 100 of an embodiment of the disclosure may be a hollow structure in other words. In addition, the first diffusively reflective element 110 and the second diffusively reflective element 120 may be formed on the inner surface 102 of the integration rod 100 by etching or in other manners, and the disclosure is not limited thereto.

The first diffusively reflective element 110 and the second diffusively reflective element 120 are configured to generate diffuse reflection surfaces with different hazes when incident light irradiates the first diffusively reflective element 110 and the second diffusively reflective element 120. In FIG. 1, the number of the first diffusively reflective element 110 and the number of the second diffusively reflective element 120 are each one as an example, but the disclosure is not limited thereto. In other embodiments, the respective numbers of the first diffusively reflective element 110 and the second diffusively reflective element 120 may each be one or more. In addition, the form of the diffuse reflection surface is not limited to a Gaussian type or a flat top type, nor is the disclosure limited thereto.

In addition, the integration rod 100 may have an optical axis A. Here, the optical axis A may be a central axis passing through a light incident surface of the integration rod 100, wherein the light incident surface is, for example, a plane formed by the direction X and the direction Y in FIG. 1, a direction of the central axis is, for example, parallel to the direction Z in FIG. 1. The light inlet 101 may be intersection points of light incident surface and the optical axis A. In this embodiment, the light inlet 101 may represent the positions where laser light beams of different wavelengths are focused when incident to the integration rod 100. Nonetheless, the disclosure is not limited thereto. In other embodiments, when light emitted by the light source is not completely concentrated into one light beam, the direction of the light beam may refer to the transmission direction of the light beam with the most intense energy among light emitted by the light source in each direction.

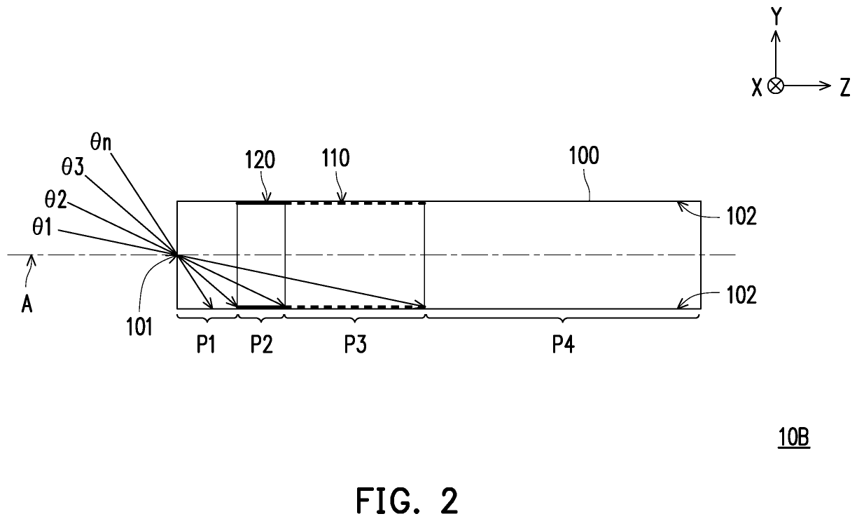

For ease of description, the definition of angle below refers to the angle between the incident ray of each light beam and the optical axis A. In other words, in FIG. 1 and FIG. 2, a first angle θ1 is smaller than a second angle θ2, and the second angle θ2 is smaller than a third angle θ3. In addition, a maximum light incident angle θn represents the maximum incident angle that can be diffusely reflected by the first diffusively reflective element 110 and the second diffusively reflective element 120 of the integration rod 100.

In this embodiment, a haze of the first diffusively reflective element 110 is greater than a haze of the second diffusively reflective element 120. From another perspective, the diffusion angle caused by the first diffusively reflective element 110 is greater than the diffusion angle of the second diffusively reflective element 120.

When light beams at different angles (e.g., laser light beams of different wavelengths) are incident to the integration rod 100, the integration rod 100 may achieve different degrees of light homogenization according to incident lights at different angles. For example, when incident light at a small angle, such as incident light at an incident angle from the first angle θ1 to the second angle θ2, enters the integration rod 100 from the light inlet 101, since the first diffusively reflective element 110 is disposed at a position farther away from the light inlet 101 than the second diffusively reflective element 120, the first diffusively reflective element 110 may receive incident light at an incident angle ranging from the first angle θ1 to the second angle θ2. Due to the smaller incident angle of incident light ranging from the first angle θ1 to the second angle θ2, the number of reflections of incident light in the integration rod 100 is relatively small. Because the incident light at a small angle may be incident to the first diffusively reflective element 110 having a relatively great haze, the incident light at a relatively small angle may still be fully homogenized.

In addition, when incident light at an incident angle from the second angle θ2 to the third angle θ3 enters the integration rod 100 from the light inlet 101, since the second diffusively reflective element 120 is disposed at a position closer to the light inlet 101 than the first diffusively reflective element 110, the second diffusively reflective element 120 may receive incident light at an incident angle ranging from the second angle θ2 to the third angle θ3. Due to the larger incident angle of incident light ranging from the second angle θ2 to the third angle θ3, the number of reflections of incident light in the integration rod 100 is relatively large. Because the incident light at a large angle is incident to the second diffusively reflective element 120 having a relatively small haze, thus reducing generation of emitted light at a relatively large angle after being diffused on the second diffusively reflective element 120, and preventing the loss of light energy of incident light at a large angle. As a result, in an embodiment of the disclosure, the integration rod 100 effectively homogenizes incident light at regardless of a large angle or a small angle, and further achieves despeckling or reducing speckle contrast.

In some embodiments, a distance Le from an end 110e of the first diffusively reflective element 110 away from the light inlet 101 to the light inlet 101 may be less than half of a length L of the integration rod 100. The inner surface 102 that is not provided with the first diffusively reflective element 110 and the second diffusively reflective element 120 may be provided with a high-reflectivity material (e.g., metal coating), which may further homogenize or shape the incident light beam, facilitating homogenization of the light beam.

In some embodiments, to achieve that the haze of the first diffusively reflective element 110 is greater than the haze of the second diffusively reflective element 120, reflective surface structures having different roughnesses may be manufactured on the first diffusively reflective element 110 and the second diffusively reflective element 120. For example, the first diffusively reflective element 110 and the second diffusively reflective element 120 are manufactured by adopting different etching processes, and the disclosure is not limited thereto.

In addition, the first diffusively reflective element 110 and the second diffusively reflective element 120 may have the same length. For example, in the direction of the optical axis A of the integration rod 100 (or the direction parallel to the direction Z in FIG. 1), a length L1 of the first diffusively reflective element 110 may be equal to a length L2 of the second diffusively reflective element 120. Nonetheless, the disclosure is not limited thereto.

In some embodiments, the difference between the second angle θ2 and the first angle θ1 is less than or equal to the difference between the third angle θ3 and the second angle θ2, and the first diffusively reflective element 110 and the second diffusively reflective element 120 have different lengths.

For example, the first angle θ1 may be 10 degrees, the second angle θ2 may be 13 degrees, and the third angle θ3 may be 18 degrees. The first diffusively reflective element 110 is configured to receive a light beam at an incident angle ranging from the first angle θ1 to the second angle θ2. The second diffusively reflective element 120 is configured to receive a light beam at an incident angle ranging from the second angle θ2 to the third angle θ3. The length L1 of the first diffusively reflective element 110 may be greater than the length L2 of the second diffusively reflective element 120. Light beams at all the angles are fully homogenized through the above. Nonetheless, the disclosure is not limited thereto.

Further, the length L1 of the first diffusively reflective element 110 may be set to

$$\frac{h}{2} \times ( cot θ 1 - cot θ 2 ) ,$$

and the length L2 of the second diffusively reflective element 120 may be set to

$$\frac{h}{2} \times ( cot θ 2 - cot θ 3 ) ,$$

where h is a thickness of the integration rod 100. Further, the thickness h refers to a thickness of the hollow structure of the integration rod 100 in the direction Y. θ1 is the first angle, θ2 is the second angle, and θ3 is the third angle. Accordingly, the first diffusively reflective element 110 may further fully receives the light beam at a small angle, homogenizing the light beam at a small angle; and the second diffusively reflective element 120 may receive the light beam at a large angle, preventing serious scattering of the light beam at a large angle, and maximally preventing the loss of light energy.

In addition, in an embodiment of the disclosure, the maximum light incident angle θn of the uniform light module 10A can satisfy the following formula:

$$\frac{h}{2} \times ( cot θ 3 ) + h \times cot ( θ 3 + θ {2}^{′} ) > \frac{h}{2} \times cot θ 1 ,$$

where h is a thickness of the integration rod, θ1 is the first angle, θ2 is the second angle, θ3 is the third angle, and θ2′ is the full width at half maximum of the haze angle of the second diffusively reflective element 120. If the maximum light incident angle is θn, the third angle θ3 in this Formula is replaced with the maximum light incident angle θn.

For example, the length L of the integration rod 100 in the direction of the optical axis A may be less than 100 millimeters (mm); the thickness h in the direction Y may be less than 8 mm; the width in the direction X may be less than 11 mm (the light incident surface of the light inlet 101 of the integration rod 100 is a rectangle, where the short side is the thickness in the direction Y, and the long side is the width in the direction X). According to the above, for example, the first angle θ1 is 10 degrees, the second angle θ2 is 13 degrees, and the third angle θ3 is 18 degrees. Accordingly, in this embodiment, taking the short side being 8 mm as an example for calculation, it follows that the length L1 of the first diffusively reflective element 110 is less than 5.36 mm according to Formula above:

$$\frac{h}{2} \times ( cot θ 1 - cot θ 2 ) ;$$

and the length L2 of the second diffusively reflective element 120 is less than 5.02 mm according to Formula above:

$$\frac{h}{2} \times ( cot θ 2 - cot θ 3 ) .$$

In addition, as can be seen from FIG. 1,

$$\frac{h}{2} \times ( cot θ 1 )$$

is the distance Le from the distal end 110e of the first diffusively reflective element 110 away from the light inlet 101 to the light inlet 101, which can be further calculated to be at a place about 22.69 millimeters; the distance from the other distal end of the first diffusively reflective element 110 (corresponding to incident light at θ2 to the inner surface 102) to the light inlet 101 in the direction Z is

$$\frac{h}{2} \times ( cot θ 2 ) ,$$

which can be further calculated to be at a place about 17.33 mm. Accordingly, it can be known that the first diffusively reflective element 110 may be disposed at a place about 17.33 mm to 22.69 mm away from the light inlet 101. In addition, it can be seen from FIG. 1 that

$$\frac{h}{2} \times ( cot θ 3 )$$

is the distance in the direction Z from the distal end of the second diffusively reflective element 120 (corresponding to incident light at θ3 to the inner surface 102) to the light inlet 101, which can be further calculated to be at a place about 12.31 mm. Since the other distal end of the second diffusively reflective element 120 is adjacent to the other distal end of the first diffusively reflective element 110 (corresponding to incident light at θ2 to the inner surface 102), it can be known that the distance from the other distal end of the second diffusively reflective element 120 to the light inlet 101 is also

$$\frac{h}{2} \times ( cot θ 2 ) ,$$

which is at a place about 17.33 millimeters. Accordingly, it can be known that the second diffusively reflective element 120 may be disposed at a place about 12.31 mm to 17.33 mm away from the light inlet 101. Nonetheless, the disclosure does not so limit the dimensions of the integration rod 100. Through the configuration above, it is possible that after a light beam incident to the second diffusively reflective element 120 on the inner surface 102 at a large angle (e.g., a light beam at an incident angle from the second angle θ2 to the third angle θ3) is reflected, most of the diffusely reflected light thereof is not incident to the first diffusively reflective element 110 on the inner surface 102 on the other side. Accordingly, it is possible that incident lights at different angles are respectively homogenized by the corresponding diffusively reflective elements, namely respective homogenizations of incident light at a large angle and incident light at a small angle do not affect each other, achieving appropriate light homogenization.

Some other embodiments will be provided below to describe the disclosure in detail, where the same components will be labeled with the same reference numerals, and description of the same technical content will be omitted. Reference may be made to the embodiments above for the omitted parts, which will not be repeatedly described below.

FIG. 2 is a schematic cross-sectional view of a light homogenization module of another embodiment of the disclosure. With reference to FIG. 2, a light homogenization module 10B of this embodiment is similar to the light homogenization module 10A of FIG. 1, and the differences are: the integration rod 100 includes a first portion P1, a second portion P2, a third portion P3, and a fourth portion P4 assembled together, and the first diffusively reflective element 110 and the second diffusively reflective element 120 are respectively disposed on the inner surface 102 at the third portion P3 and the second portion P2.

Specifically, the first portion P1, the second portion P2, the third portion P3, and the fourth portion P4 are disposed sequentially from closeness to the light inlet 101 to remoteness from the light inlet 101, for example. Moreover, the integration rod 100 of the light homogenization module 10B may be formed by first separately manufacturing different parts and then splicing them together. For example, the integration rod 100 may be formed by first manufacturing the third portion P3 and the second portion P2 separately, and then combining the third portion P3 and the second portion P2 with the first portion P1 and the fourth portion P4. Accordingly, it facilitates determining the size of each part, and it is possible to flexibly set the lengths required by the first diffusively reflective element 110 and the second diffusively reflective element 120 in the integration rod 100, and freely adjust the haze required by the integration rod 100.

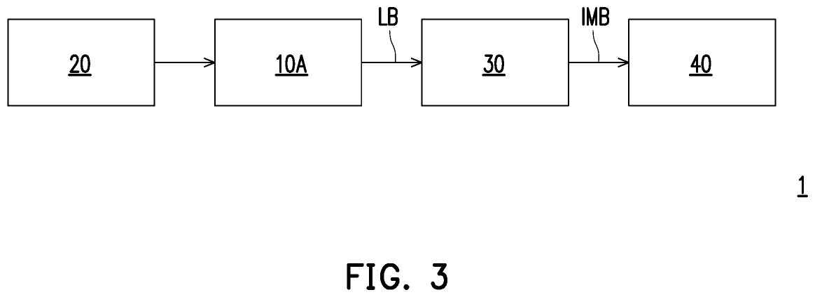

FIG. 3 is a schematic view of an optical path of a projection apparatus of an embodiment of the disclosure. With reference to FIG. 1, FIG. 2, and FIG. 3, the light homogenization modules of the embodiments above may each be disposed in a projection apparatus 1 of this embodiment. The light homogenization module 10A of FIG. 1 being disposed in the projection apparatus 1 of this embodiment will be taken as an example below. In this embodiment, the projection apparatus 1 includes a light homogenization module 10A, an illumination system 20, a light valve 30, and a projection lens 40. The light homogenization module 10A is disposed between the illumination system 20 and the light valve 30. The illumination system 20 may include an excitation light source array, a multi-region dichroic device, a color sequence generator, and a wavelength converter (not shown) for emitting an illumination light beam LB, and the disclosure is not limited thereto. The light valve 30 is disposed on a transmission path of the illumination light beam LB from the illumination system 20 to convert the illumination light beam LB homogenized by the light homogenization module 10A into an image light beam IMB. In this embodiment, the light valve 30 is a digital micro-mirror device (DMD) or a liquid-crystal-on-silicon panel (LCOS panel), for example. Nonetheless, in other embodiments, the light valve 30 may also be a transmissive liquid crystal panel. The projection lens 40 is disposed on a transmission path of the image light beam IMB to project the image light beam IMB out of the projection apparatus 1, for example, to project the image light beam IMB on a screen to form an image frame.

In summary of the foregoing, in the light homogenization module and the projection apparatus of the embodiments of the disclosure, the integration rod includes the first diffusively reflective element and the second diffusively reflective element with different hazes on the inner surface. As a result, under the same length of the integration rod, it is possible to effectively improve the light homogenization capability of the incident light within a small angle range, and also reduce the loss of light energy caused by diffusion of the incident light at a large angle. Moreover, the light beam is fully homogenized in the integration rod to technically achieve despeckling or reducing speckle contrast, and provide good image quality. In addition, under the same condition of light homogenization, since the integration rod of an embodiment of the disclosure may cause light homogenization with different internal diffusively reflective elements corresponding to incident lights at different angles, an excessively great number of reflections is not required to fully achieve light homogenization for incident light at a small angle. As a result, the length of the integration rod may be further reduced, which in turn further reduces the overall volume of the projection apparatus, facilitating miniaturization of the projection apparatus.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A light homogenization module comprising:
an integration rod having a light inlet and an inner surface;
a first diffusively reflective element disposed on the inner surface of the integration rod; and
a second diffusively reflective element disposed on the inner surface of the integration rod and adjacent to the first diffusively reflective element;
wherein the second diffusively reflective element is disposed between the first diffusively reflective element and the light inlet of the integration rod, and a haze of the first diffusively reflective element is greater than a haze of the second diffusively reflective element.

2. The light homogenization module according to claim 1, wherein a distance from an end of the first diffusively reflective element away from the light inlet to the light inlet is less than half of a length of the integration rod.

3. The light homogenization module according to claim 1, wherein the first diffusively reflective element and the second diffusively reflective element have different roughnesses.

4. The light homogenization module according to claim 1, wherein the first diffusively reflective element and the second diffusively reflective element have the same length.

5. The light homogenization module according to claim 1, wherein the first diffusively reflective element is disposed at a place 17.33 millimeters to 22.69 millimeters away from the light inlet, and the second diffusively reflective element is disposed at a place 12.31 millimeters to 17.33 millimeters away from the light inlet.

6. The light homogenization module according to claim 1, wherein the integration rod comprises a first portion, a second portion, a third portion, and a fourth portion assembled together, and the first diffusively reflective element and the second diffusively reflective element are respectively disposed on the inner surface at the third portion and the second portion.

7. A projection apparatus comprising:
an illumination system configured to output an illumination light beam;
a light homogenization module disposed on a transmission path of the illumination light beam and homogenizing the illumination light beam, wherein the light homogenization module comprises:
an integration rod having a light inlet and an inner surface;
a first diffusively reflective element disposed on the inner surface of the integration rod; and
a second diffusively reflective element disposed on the inner surface of the integration rod and adjacent to the first diffusively reflective element, wherein the second diffusively reflective element is disposed between the first diffusively reflective element and the light inlet of the integration rod, and a haze of the first diffusively reflective element is greater than a haze of the second diffusively reflective element;
a light valve disposed on a transmission path of the illumination light beam homogenized by the light homogenization module, and the light valve converting the illumination light beam into an image light beam; and
a projection lens disposed on a transmission path of the image light beam.

8. The projection apparatus according to claim 7, wherein a distance from an end of the first diffusively reflective element away from the light inlet to the light inlet is less than half of a length of the integration rod.

9. The projection apparatus according to claim 7, wherein the first diffusively reflective element and the second diffusively reflective element have different roughnesses.

10. The projection apparatus according to claim 7, wherein the first diffusively reflective element and the second diffusively reflective element have the same length.

11. The projection apparatus according to claim 7, wherein the first diffusively reflective element is disposed at a place 17.33 millimeters to 22.69 millimeters away from the light inlet, and the second diffusively reflective element is disposed at a place 12.31 millimeters to 17.33 millimeters away from the light inlet.

12. The projection apparatus according to claim 7, wherein the integration rod comprises a first portion, a second portion, a third portion, and a fourth portion assembled together, and the first diffusively reflective element and the second diffusively reflective element are respectively disposed on the inner surface at the third portion and the second portion.
